(19) United States
(12) Patent Application Publication
(10) Pub. No.: US 2017/0040097 A1
(43) Pub. Date: Feb. 9, 2017

(54) SWITCHING CONVERTER CIRCUIT WITH AN INTEGRATED TRANSFORMER

(71) Applicant: ABB AG, Mannheim (DE)

(72) Inventor: Raymond Wee, Buehl (DE)

(21) Appl. No.: 15/331,915

(22) Filed: Oct. 24, 2016

Related U.S. Application Data
(63) Continuation of application No. PCT/EP2015/060149, filed on May 8, 2015.

(30) Foreign Application Priority Data
May 28, 2014 (EP) 14 001 855.7

(51) Int. Cl. H01F 27/00; H01F 3/14; H02M 3/24

(52) U.S. Cl. CPC H01F 27/00; H02M 3/24; H01F 3/14

(57) ABSTRACT

A switching converter circuit has an integrated transformer, wherein the transformer has a double loop magnetic structure with an E I core geometry, wherein the primary and secondary windings are placed side by side on the center leg of the E-part of the core, wherein the air gap is placed at the far end of the primary winding between the free end of the center leg and the I-part of the core.

### CROSS-REFERENCE TO RELATED APPLICATIONS

This application is a bypass continuation of PCT/EP2015/060149, filed on May 8, 2015, and claims benefit to European Patent Application No. 14 001 855.7 filed on May 28, 2014, the entire disclosure of each of which is hereby incorporated by reference herein. The International Application was published in English on Dec. 3, 2015, as WO 2015/180944 A1 under PCT Article 21(2).

### FIELD

The invention relates to a switching converter circuit with an integrated transformer, for such applications as DC-to-DC converters.

### BACKGROUND

Electronic switch-mode DC-to-DC converters convert one DC voltage level to another, by storing the input energy temporarily and then releasing that energy to the output at a different voltage. The storage may be in magnetic field storage components such as transformers. In a magnetic DC-to-DC converter, energy is periodically stored into and released from a magnetic field in an inductor or a transformer, typically in the range from 300 kHz to 10 MHz. By adjusting the duty cycle of the charging voltage, that is the ratio of on/off time, the amount of power transferred can be controlled. Transformer based converters may provide isolation between the input and the output. These circuits are the heart of a switched-mode power supply.

Resonant converters such as the LLC converter is gaining popularity as an efficient DC-DC power conversion stage with wide spread applications.

To reduce material cost and minimizing the converter volume, the resonant choke of the power stage is designed into the main transformer as an integrated entity, forming a so called integrated transformer, thus, reducing the part count compared to a discrete solution which needs a physical resonant choke.

The design of an integrated transformer with minimized core and copper losses based on given power carrying capability and electrical design constraints would result in an optimize ferrite core size and copper cross-section area required to maintain the targeted loss figure. The optimized core size and volume would also imply a fixed winding area available for the copper windings.

U.S. Pat. No. 5,790,005 shows a switching converter circuit comprising a single-loop core of magnetic material, series input and series output inductors loosely coupled by winding said inductors on opposite legs of said single-loop core, only one of said legs having an effective total gap, said input and output inductors having the same number of turns for zero ripple current in said output winding. There is quite a long core length in this single loop core between the primary and the secondary windings, resulting in a still significant core loss.

Other state of the art solutions position the air gap within the center leg length of a double loop magnetic structure, usually in the middle with standard symmetrical E-cores, incurring high copper losses in the windings, which usually are made of copper, in the vicinity of the air gap. This arrangement also decreases the coupling factor k between primary and secondary windings for a given number of turns which could be observed with a high leakage inductance measured at the primary turns with the secondary short circuited. This leakage inductance is essentially the resonant inductance which is intentionally integrated into the magnetic component.

The background solutions to solve the copper losses in the windings due to air gap fringe flux is either to keep the copper windings away from the gap area or to extend the core length such that the copper windings can be placed at a sufficient distance away from the air gap to maintain the efficiency. Both compromise an optimized transformer design. The first will force the reduction in copper windings cross section area in order to make space for the air gap standoff, thus increasing the copper winding loss figure and also complicates the manufacturing process with a densely wound winding. The second approach increases core loss by extending the core length needed for the standoff. Besides, increasing the core length increases the effective magnetic path length which has a direct negative impact on the AC core geometry factor required for the targeted compact design. The AC core geometry factor is a figure of merit used to assess a transformer core's power handling capability including the consideration on AC core loss for the intended design.

### SUMMARY

An aspect of the invention provides a switching converter circuit, comprising: an integrated transformer, wherein the transformer includes a double loop magnetic structure having an E I core geometry, a primary winding, a secondary winding, a center leg, a core, an air gap, an E-part, and an I-part, wherein the primary and secondary windings are arranged side by side on the center leg of the E-part of the core, wherein the air gap is arranged at a far end of the primary winding between a free end of the center leg and the I-part of the core.

### BRIEF DESCRIPTION OF THE DRAWINGS

The present invention will be described in even greater detail below based on the exemplary figure. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a transformer configuration with an E I-core structure according to the invention.

### DETAILED DESCRIPTION

In view of the background it is an aspect of the present invention to provide a switching converter circuit with an integrated transformer with reduced losses and reduced converter size.

According to an aspect of the invention, the transformer has a double loop magnetic structure with an E-I core geometry, wherein the primary and secondary windings are placed side by side on the center leg of the E-part of the core, wherein the air gap is placed at the far end of the primary winding between the free end of the center leg and the I-part of the core.

According to a preferred embodiment of the invention, a switching converter circuit comprises a double loop core of magnetic material, having two single loops of magnetic material combined to form a frame-like structure sharing one center leg common to both loops, the only air gap positioned between the free end of the center leg and the frame-like structure, further comprising a primary winding and a secondary winding, said primary and secondary windings being coupled by winding said windings on the center leg.

According to an advantageous embodiment of the invention, the primary winding is wound on said center leg in a section close to the air gap, wherein the secondary winding is wound on said center leg in a section at the far end from the air gap. The primary winding is positioned on the center leg between the air gap and the secondary conductor winding.

The proposed embodiment of the invention by placing the air gap at the far side of the primary winding group enables the important possibility of reducing the leakage inductance needed for the integrated transformer action for the optimized turns number and at the same time reducing effective core length between the primary and secondary windings. The low leakage inductance can then be coupled with a larger resonant capacitor to reduce the voltage stress for the same power processing level while maintaining high switching frequency to keep the magnetic design compact. The low leakage inductance also means higher coupling factor between the primary and secondary winding group, thus preventing further increasing of additional turns on the primary to compensate for a loosely coupled transformer, of which would further increase copper losses

The invention renders a solution to optimize losses and reducing the converter size focusing the integrated transformer in the said power conversion stage implemented with a double loop magnetic structure, e.g. integrated transformers formed by a combination of E structure cores or E-I cores, namely, the primary winding occupying the center leg structure with the secondary winding side by side to it.

The invention enables the winding area utilization to be kept high without compromising the transformer design already optimized in respect of core and copper loss, thus enabling the component to stay compact and minimize losses due to fringe flux at the vicinity of the air gap, which is a problem in prior art solutions.

According to an advantageous embodiment of the invention, the center leg has a round cross-sectional contour.

According to an advantageous embodiment of the invention, the center leg has a rectangular or a quadratic cross-sectional contour.

According to an advantageous embodiment of the invention, the core is made of a ferritic material.

According to an advantageous embodiment of the invention, the core is made of a laminated metal sheet arrangement.

According to an advantageous embodiment of the invention, the diameter or the geometrical outline dimension of the center leg of the core is larger than the width of the air gap, preferably in another advantageous embodiment larger than five times the width of the air gap.

According to an advantageous embodiment of the invention, the length of the center leg of the core is larger than the width of the air gap, preferably in another advantageous embodiment larger than five times the width of the air gap.

The integrated transformer 1 has a double loop core 2 of magnetic material. The double loop core 2 is composed of two single loops 10, 11 loops of magnetic material sharing one center leg 5. The first loop 10 thus is composed of a first long leg 12, two short legs 14a, 15a and a center leg 5. The center leg 5 is connected to one of the short legs of the first loop 10, here in the example the right-hand side short leg 14a. The second loop is composed of a second long leg 13, two short legs 14b, 15b and the same center leg 5. The center leg 5 is also connected to one of the short legs of the second loop, here in the example the right-hand side short leg 14b. The two right-hand side short legs 14a and 14b of the first and second loop are connected at their narrow sides, as are the left-hand side short legs 15a and 15b of the first and second loop 10, 11.

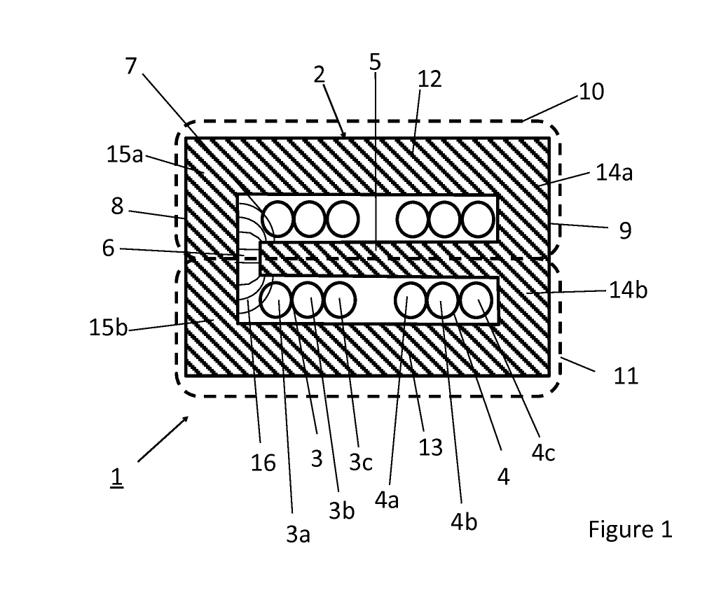

So looking at the composition of both loops in FIG. 1, the core has the overall cross-sectional contour of a rectangular frame or frame-like structure, with a center leg 5 reaching out from one of the short sides of the rectangular frame, the side composed of the short legs 14a, 14b, towards the opposite short side 8 of the rectangular frame, the short side composed of the short legs 15a, 15b.

The center leg, however, does not reach up to the second short side, but leaves a small air gap 6 between its free front end and the second short side 8 composed of the short legs 15a, 15b.

So the center leg 5 is common to both loops 10, 11. The integrated transformer 1 further has a primary winding 3 and a secondary winding 4. The primary and secondary winding windings 3, 4 are coupled by winding them on the center leg 5. Only the center leg 5 forms an effective total air gap 6 with the opposing short side 8 of the rectangular frame-like structure.

The primary winding 3 is wound on the center leg 5 in a section close to the air gap 6, here in the example of FIG. 1 on the left-hand part of the center leg 5, close to the air gap 6. The secondary winding 4 is wound on the center leg 5 in a section at the far end from the air gap 6, here in the example of FIG. 1 on the right-hand part of the center leg 5, away from the air gap. The primary winding 3 is thus positioned between the air gap 6 and the secondary winding 4.

The primary and secondary windings 3, 4 are in the example of FIG. 1 exemplarily shown with three loops 3a, 3b, 3c, 4a, 4b, 4c each, i.e. an equal number of loops each. It could of course also be more or less than three windings, and of course the primary winding 3 could as well have more or less loops than the secondary winding 4.

In other words and looking at the transformer 1 shown in FIG. 1 with a different view, the transformer 1 has a double loop magnetic structure with an E-I core geometry, wherein the two long legs 12, 13, connected by the combination of right-hand side short legs 14a, 14b and the center leg 5 form the E part 9, and the combination of the two left-hand side short legs 15a, 15b form the I part 8. The primary and secondary windings 3, 4 are placed side by side on the center leg 5 of the E-part of the core. The air gap is placed only at the far end of the primary winding 3 between the free end of the center leg 5 and the I-part of the core. The primary winding 3 is thus positioned between the air gap 6 and the secondary winding 4.

Due to the high magnetic reluctance of the air gap just next to the primary windings, the stray field generated in the whole structure is being reduced resulting in a lower leakage inductance. The stray field or fringe field occurs in close neighborhood to the air gap 6, as indicated in FIG. 1 by field lines 16. This local stray field or fringe field only affects the copper loss due to the fringe field at the far-end part 7 of the primary winding 3 in close neighborhood to the air gap 6. The secondary winding 4 is not affected by the air gap fringe or stray field 16.

Accordingly, the secondary winding 4 is out of reach of the fringe field 16. Primary winding 3 is only partly in reach of the stray field 16. This is why in the arrangement according to the invention, the stray-field induced influence and losses in the winding windings 3, 4 are very low, merely only resulting from a small interaction of the stray field 16 with a small partition 7 of the primary winding 3. Still the primary and secondary windings 3, 4 can be arranged closely together, reducing the length of the center leg 5 which magnetically couples both windings 3, 4. This results in the beneficial properties of low stray-field induced losses and small core losses.

With the given resonant transformer 1 construction according to the FIG. 1, the positioning of the air gap 6 at the far end of primary winding 3, remote from the secondary winding 4, reduces the overall copper winding losses. It reduces the overall leakage inductance seen into the primary winding 3, thus, increases the primary and secondary coupling. The leakage inductance in this state is sufficient for the operation of the resonant tank in the switching converter where the integrated transformer 1 is applied.

Since no large winding space gap, no large gap between the primary and secondary windings 3, 4 is needed to stay clear of stray flux, the overall utilization of the winding area is not compromised by needing to increase the core or of reducing the copper current carrying cross section in the optimized low loss design.

The center leg 5 can have a round cross-sectional contour or a rectangular or even quadratic contour cross section. Particularly, the center leg 5 can have a cross-sectional contour which is different to the cross-sectional contour of the outer frame of the transformer core. Also, the diameter of the center leg 5 can be smaller than the diameter of the remaining frame of the transformer core 2.

The core 2 can be made of a ferritic material or of a laminated metal sheet arrangement.

The diameter of the center leg 5 of the core is larger than the width of the air gap 6, particularly it is larger than five times the width of the air gap 6.

Also, the length of the center leg 5 is larger than the width of the air gap 6, particularly it is larger than five times the width of the air gap 6.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SIGNS

1 integrated transformer
2 double loop core, E-I core
3 primary winding
3a winding loop
3b winding loop
3c winding loop
4 secondary winding
4a winding loop
4b winding loop
4c winding loop
5 center leg
6 air gap
7 far end of primary winding 3
8 I-part
9 E-part
10 first loop
11 second loop
12 first long leg
13 second long leg
14a short leg
14b short leg
15a short leg
15b short leg
16 field line

1. A switching converter circuit, comprising:
an integrated transformer,
wherein the transformer includes a double loop magnetic structure having an E I core geometry, a primary winding, a secondary winding, a center leg, a core, an air gap, an E-part, and an I-part,
wherein the primary and secondary windings are arranged side by side on the center leg of the E-part of the core,
wherein the air gap is arranged at a far end of the primary winding between a free end of the center leg and the I-part of the core.

2. A switching converter circuit, comprising:
a double loop core including a magnetic material, and further including a first single loop and a second single loop, the loops including magnetic material, combined to form a frame-like structure sharing one center leg common to both of the loops, only one air gap being positioned between a free end of the center leg and the frame-like structure;
a primary winding; and
a secondary winding,
wherein the primary and secondary windings are coupled by a winding of the primary and secondary windings on the center leg.

3. The circuit of claim 2, wherein the primary winding is wound on the center leg in a section close to the air gap.

4. The circuit of claim 3, wherein the secondary winding is wound on the center leg in a section at a far end from the air gap.

5. The circuit of claim 4, wherein the primary winding is wound on the center leg between the air gap and the secondary winding.

6. The circuit of claim 1, wherein the center leg has a round cross-sectional contour.

7. The circuit of claim 2, wherein the center leg has a round cross-sectional contour.

8. The circuit of claim 1, wherein the center leg has a rectangular or a quadratic cross-sectional contour.

9. The circuit of claim 2, wherein the center leg has a rectangular or a quadratic cross-sectional contour.

10. The circuit of claim 1, wherein the core includes a ferritic material.

11. The circuit of claim 1, wherein the core is made of a ferritic material.

12. The circuit of claim 2, wherein the core includes a ferritic material.

13. The circuit of claim 2, wherein the core is made of a ferritic material.

14. The circuit of claim 1, wherein the core is made of a laminated metal sheet arrangement.

15. The circuit of claim 1, wherein a diameter or geometrical outline dimension of the center leg of the core is larger than a width of the air gap.

16. The circuit of claim 15, wherein the diameter or geometrical outline dimension of the center leg of the core is larger than five times the width of the air gap.

17. The circuit of claim 1, wherein a length of the center leg is larger than a width of the air gap.

18. The converter of claim 17, wherein the length of the center leg is larger than five times the width of the air gap.
